(19) United States
(12) Patent Application Publication
(10) Pub. No.: US 2025/0292588 A1
(43) Pub. Date: Sep. 18, 2025

(54) SYSTEMS AND METHODS FOR OBTAINING VIDEO ANALYTIC OUTPUT

(71) Applicant: Toyota Motor Engineering & Manufacturing North America, Inc., Plano, TX (US)

(72) Inventors: Yitao Chen, Tempe, AZ (US); Dawei Chen, Milpitas, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/430,242

(22) Filed: Feb. 1, 2024

(51) Int. Cl. G06V 20/58; B60W 60/00; G06N 20/00; G06V 10/70

(52) U.S. Cl. CPC G06V 20/58; B60W 60/001; G06N 20/00; G06V 10/70

(57) ABSTRACT

A system includes a vehicle. The vehicle includes a controller configured to obtain video data, determine a confidence of a specialized model by inputting the obtained video data to the specialized model, determine whether the confidence is greater than a predetermined value, send the obtained video data to an edge server in response to determining that the confidence is less than or equal to the predetermined value, and operate the vehicle using an output of the specialized model in response to determining that the confidence is greater than the predetermined value.

### TECHNICAL FIELD

The present disclosure relates to systems and methods for obtaining video analytic output, more specifically obtaining video analytic output using a specialized model locally stored in a vehicle.

### BACKGROUND

Accurately analyzing videos obtained from vehicles may be desired for many reasons. However, conventional systems and methods are performed with reduced speed due to large amount and size of video data and low computation capability for recognizing objects in the constantly changing video streams.

Accordingly, a need exists for systems and methods that accurately analyze videos obtains from the vehicle with improved speed.

### SUMMARY

The present disclosure provides systems and methods for obtaining video analytic output. By determining a confidence of a specialized model and comparing the confidence to a predetermined value, the systems and methods may determine whether to retrain the specialized model. With the specialized model, the systems and methods may accurately obtain video analytic output with increased efficiency, thereby avoiding an undesirable situation.

In one or more embodiments, a system includes a vehicle including a controller configured to obtain video data, determine a confidence of a specialized model by inputting the obtained video data to the specialized model, determine whether the confidence is greater than a predetermined value, send the obtained video data to an edge server in response to determining that the confidence is less than or equal to the predetermined value, and operate the vehicle using an output of the specialized model in response to determining that the confidence is greater than the predetermined value.

In another embodiment, a method for responding a request for a negotiation, the method comprising obtaining video data, determining a confidence of a specialized model by inputting the obtained video data to the specialized model, determining whether the confidence is greater than a predetermined value, sending the obtained video data to an edge server in response to determining that the confidence is less than or equal to the predetermined value, and operating the vehicle using an output of the specialized model in response to determining that the confidence is greater than the predetermined value.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1A and 1B schematically depict an exemplary embodiment of for obtaining video analytic output, according to one or more embodiments shown and described herein;

FIG. 2 depicts a schematic diagram of a system for obtaining video analytic output, according to one or more embodiments shown and described herein;

FIG. 3 depicts a flowchart for a method of for obtaining video analytic output request, according to one or more embodiments shown and described herein; and

FIG. 4 depicts a flowchart for a method of for obtaining video analytic output request, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The embodiments disclosed herein include systems and methods for obtaining video analytic output using a specialized model in a vehicle. By determining a confidence of the specialized model and comparing the confidence to a predetermined value, the systems and methods may determine whether to retrain the specialized model. While the specialized model may only recognize small amount of video data, the specialized model could efficiently analyze the video data. With the specialized model, the systems and methods may accurately obtain video analytic output with increased efficiency, thereby avoiding an undesirable situation.

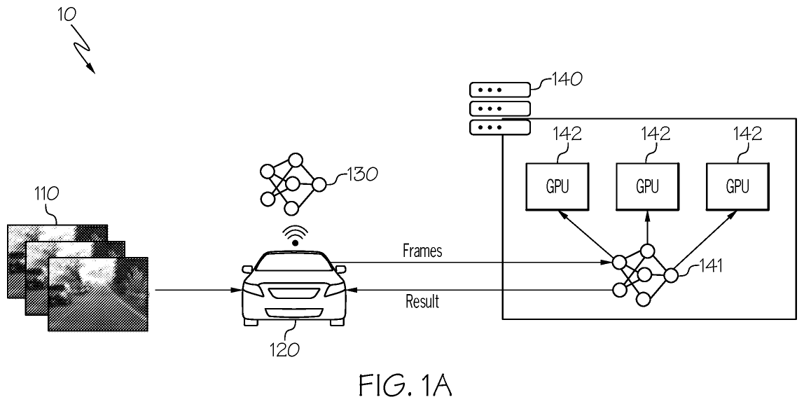

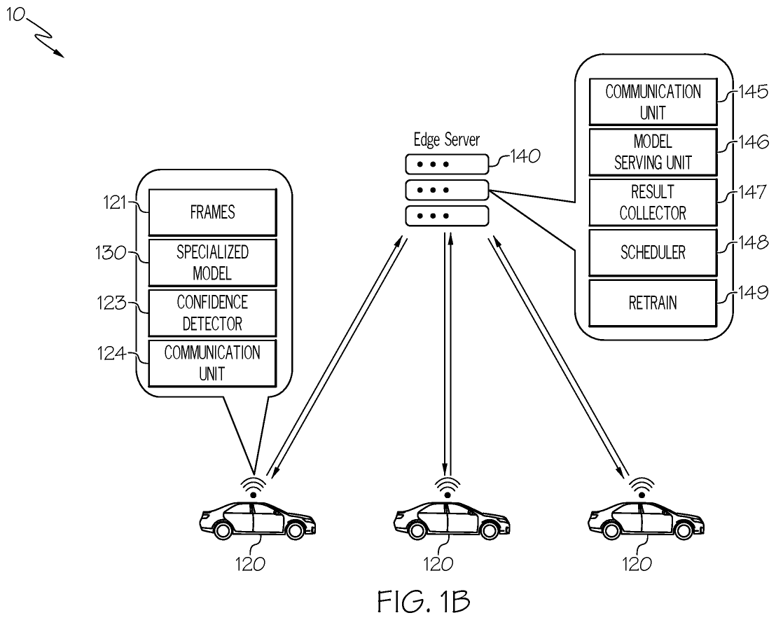

FIGS. 1A and 1B schematically depict an exemplary embodiment of for obtaining video analytic output, according to one or more embodiments shown and described herein.

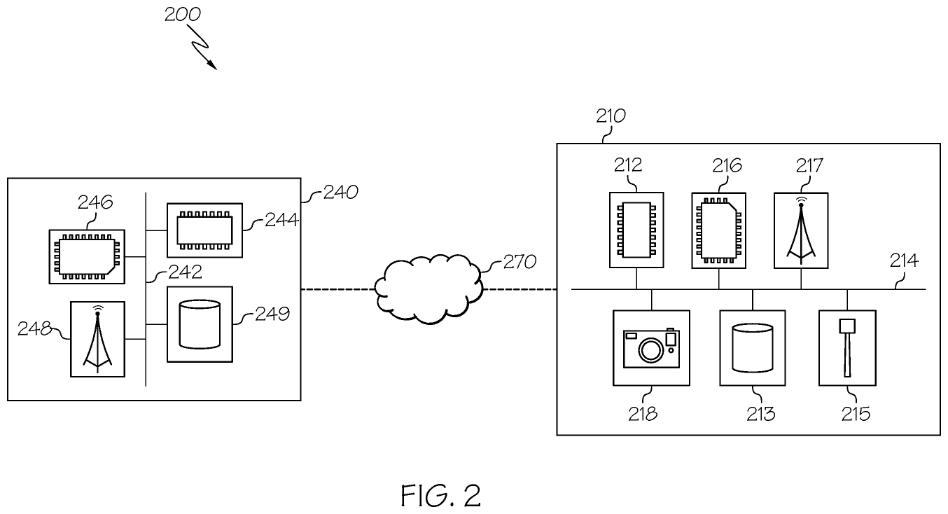

Referring to FIGS. 1A and 1B, the system 10 for obtaining video analytic output includes a vehicle 120. The vehicle 120 may be a vehicle including an automobile or any other passenger or non-passenger vehicle such as, for example, a terrestrial, aquatic, and/or airborne vehicle. In some embodiments, the vehicle 120 may be an autonomous driving vehicle. The vehicle 120 may be an autonomous vehicle that navigates its environment with limited human input or without human input. The vehicle 120 may be equipped with internet access and share data with other devices both inside and outside the vehicle 120. The vehicle 120 may communicate with the server 240 (shown in FIG. 2) and transmit its data to the server 240 (shown in FIG. 2). For example, the vehicle 120 transmits information about its current location and destination, its environment, information about a current driver, information about a task that it is currently implementing, and the like. The vehicle 120 may include an actuator such as a motor or an engine configured to move the vehicle 120.

The vehicle 120 may include a frame unit 121, a specialized model 130, a confidence detector 123, and a communication unit 124. The vehicle 120 may obtain video data 110. The video data 110 may include information about velocity of the vehicle 120, acceleration of the vehicle 120, the driving direction of the vehicle 120, environments, such as weather, road surface conditions, traffic signs, other surroundings of the vehicle 120, or combinations thereof. The video data 110 may be obtained by the image sensors. In some embodiments, the image sensors may include one or more LIDAR sensors, radar sensors, sonar sensors, or other types of sensors for gathering data that could be integrated into or supplement the data collection. Ranging sensors like radar sensors may be used to obtain rough depth and speed information for the view of the vehicle 120.

The vehicle 120 may include the frame unit 121. The frame unit 121 may collect a plurality of frames of the obtained video data 110. The term “frame” refers to a single still image that, when placed in sequence with the other frames of the video, creates motion on the playback surface.

The vehicle 120 may preprocess the obtained video data 110 to produce reduced size of the video data 110. In some embodiments, the vehicle 120 may conduct a sampling method, a subsampling method, or both, to produce reduced size of the video data 110.

In one or more embodiments, the vehicle 120 may perform an inference to obtain video analytic output. In one or more embodiments, the video analytic output may be used for autonomous driving. The video analytic output may include object identification, object classification, generating bounding boxes for objects, or combinations thereof.

The object identification may identify the object based on color, texture, shape, or combinations thereof. The object may include buildings, bridges, beacons, powerline pylons, road infrastructure objects, such as, a perimeter line of the road, a sidewalk (pavement) edge, a traffic sign, a traffic light, a roundabout entry, a roundabout exit, a turning bay entry, a turning bay exit, a road marking (e.g., a pedestrian crossing, an intersection stop line, a lane marking, a road perimeter marking, etc.), a light pole, a landmark, a traffic sign, geographical landforms, such as mountains, valleys, canyons, oceans, islands, or both, in the operational environment of the vehicle. In some embodiments, the object identification may identify the geometric features of the objects. The term “geometric features” refer features of objects constructed by a set of geometric elements such as, points, lines, curves, or surfaces. The geometric features of the objects may include drivable lanes, traffic signs and lights, or both.

The object identification may include object detection, object recognition, object tracking, or combinations thereof. The object detection may be a computer vision task for detecting and locating objects of interest in an image or video. The object recognition may be a computer vision task for finding and identifying objects in an image or video sequence. The object tracking may be a computer vision task for tracking movements of objects in space or across frames.

The object classification may identify objects by classifying them into one of the finite sets of classes, which involves comparing the measured features of a new object with those of a known object or other known criteria and determining whether the new object belongs to a particular category of objects.

Generating bounding boxes for objects may be a process of labeling or annotating an image with a bounding box around objects.

The term “inference” refers a process of using a trained model to make prediction or draw conclusion based on the provided data. The vehicle 120 may input the obtained video data 110 or preprocessed obtained video data 110 into a trained model, such as a specialized model 130, to obtain video analytic output. In response to determining that the confidence of the specialized model 130 is greater than the predetermined value, the vehicle 120 may not send the obtained video data 110, the specialized model 130, the video analytic output, or combinations thereof, to the edge server 140.

The confidence detector 123 may determine a confidence of a specialized model 130. The confidence detector 123 may determine a confidence of the specialized model 130 by inputting the obtained video data to the specialized model 130. The term “confidence” refers a value representing a likelihood that an output of the specialized model 130 is correct. In some embodiments, the confidence of the specialized model 130 may be indicated by one of numbers from 0 to 10. The high number of confidence refers to a high confidence of the specialized model 130. The high confidence of the specialized model 130 indicates that the specialized model will provide a greater degree of accuracy.

The specialized model 130 may be included in the vehicle 120. The specialized model 130 may be produced by compressing a general model 141. The general model 141 may comprise a machine learning model for processing frames in the video data 110. In one or more embodiments, the machine learning model may be an Artificial Neural Network (ANN), such as a convolutional neural network, a Deep Neural Network (DNN), or both, that may be trained using ground-truth data. The ground-truth data may be image data including multiple image frames corresponding to various signalized intersections in which objects in the images and relationships between the objects are labeled. In some embodiments, the machine learning model may employ other types of supervised machine learning algorithms, such as regression models, classifiers, or the like. In some embodiments, parameters of the general model 141 may be compressed to obtain parameters of the specialized model 130. The specialized model 130 may have a part of segments of the general model 141. The specialized model 130 may have one or a couple of characteristic of the general model 141. In one or more embodiments, the general model 141 may be in the edge server 140. A number of objects or classes recognized by the specialized model 130 may be less than a number of objects or classes recognized by the general model 141. A number of hidden layers of the specialized model 130 may be less than a number of hidden layers of the general model 141. Compared to the general model 141, the specialized model 130 efficiently analyzes the data with reduced processing time. Thus, the specialized model 130 may be deployed for efficiency of analyzing data. However, the specialized model 130 analyzes small amount or size of data, compared to the general model 141.

The vehicle 120 may determine whether the confidence is greater than a predetermined value. In some embodiments, the confidence detector 123 may determine whether the confidence is greater than a predetermined value. In response to determining that the confidence is greater than the predetermined value, the vehicle 120 may not send the obtained video data 110, the specialized model 130, or both, to the edge server 140. In response to determining that the confidence is greater than the predetermined value, the vehicle 120 may determine the obtained video analytic output from the vehicle 120 as final video analytic output for operating the vehicle 120.

The vehicle 120 may send the obtained video data 110 to the edge server 140 in response to determining that the confidence is less than or equal to the predetermined value. The vehicle 120 may send the specialized model 130 to the edge server 140 in response to determining that the confidence is less than or equal to the predetermined value. The vehicle 120 may further send the obtained video analytic data from the vehicle 120 to the edge server 140. The vehicle 120 may send the obtained video data 110, the specialized model 130, the obtained video analytic data from the vehicle 120, or combinations thereof, to the edge server 140 through the communication unit 124. The edge server 140 may retrain the specialized model 130 using the obtained video data 110 to increase the confidence of the specialized model 130. The edge server 140 may send the retrained specialized model back to the vehicle 120. Details of the processes and the elements of the edge server 140 will be described below.

The vehicle 120 may be operated using an output, such as video analytic output, of the specialized model 130 in response to determining that the confidence is greater than the predetermined value. For example, the vehicle 120 may start, change a driving direction, change a velocity, change an acceleration, stop, change a temperature of the vehicle 120, or combinations thereof, using an output of the specialized model 130 in response to determining that the confidence is greater than the predetermined value.

Still referring to FIGS. 1A and 1B, the system 10 may further include the server 240 (shown in FIG. 2). The server 240 may include a cloud server, an edge server 140, or both. In some embodiments, the server 240 may be the edge server 140. The edge server 140 may refer an edge device that provides an entry point into a network.

The edge server 140 may include a graphic processing unit 142. The graphic processing unit 142 may communicate with the general model 141 to analyze the obtained video data 110. The graphic processing unit 142 may include the communication unit 145, the model serving unit 146, the result collector 147, the scheduler 148, and the retrain unit 149.

The edge server 140 may receive the obtained video data 110, the specialized model 130, or both, from the vehicle 120 through the communication unit 145. In one or more embodiments, the edge server 140 may receive the obtained video data 110 from a plurality of vehicles including the vehicle 120. The edge server 140 may store the video data 110 received from the vehicle 120 in a frame buffer.

The edge server 140 may include a scheduler 148. The scheduler 148 may determine whether the edge server 140 is available for processing the video data 110 received from the vehicle 120.

The edge server 140 may include a model serving unit 146. In response to determining that the edge server 140 is available, the model serving unit 146 may receive the video data 110 from the frame buffer. The model serving unit 146 may include the general model 141. The general model 141 receives the video data 110 and outputs a video analytic output.

In one or more embodiments, the edge server 140 may produce the specialized model 130. The edge server 140 may produce the specialized model 130 by compressing the general model 141 and then send to the vehicle 120.

In one or more embodiments, the edge server 140 may perform an inference to obtain video analytic output. The edge server 140 may input the obtained video data 110 into a trained model, such as a general model 141, to obtain video analytic output. The general model 141 may be eligible to train the obtained video data 110 from the plurality of vehicles including the vehicle 120. The video data may be constantly changed, as the vehicle 120 is moving. The general model 141 may be eligible to recognize all objects in the constantly changing video data during training. The specialized model 130 may not be eligible to train the obtained video data 110 from the plurality of vehicles including the vehicle 120. The specialized model 130 may be eligible to train the obtained video data 110 from the vehicle 120, rather than from the plurality of vehicles. The specialized model 130 may not be eligible to recognize all objects in the constantly changing video data during training.

The edge server 140 may include a retrain unit 149. In response to determining that the confidence of the specialized model 130 is less than or equal to the predetermined value, and that the retrain unit 149 is available, the retrain unit 149 may retrain the specialized model 130 received from the vehicle 120. The retrain unit 149 may retrain the specialized model 130 with the obtained video data 110 to increase the confidence of the specialized model 130 greater than the predetermined value.

The edge server 140 may include a result collector 147. The result collector 147 may obtain the video analytic output, the retrained specialized model, or both. The result collector 147 may send the video analytic output, the retrained specialized model, the obtained video data 110 from the plurality of vehicles including the vehicle 120, or combinations thereof, to the communication unit 145.

The communication unit 145 may send the video analytic output, the retrained specialized model, the obtained video data 110 from the plurality of vehicles including the vehicle 120, or combinations thereof, to the vehicle 120. The vehicle 120 may be operated by using the video analytic output, the retrained specialized model, the obtained video data 110 from the plurality of vehicles including the vehicle 120, or combinations thereof.

FIG. 2 depicts a schematic diagram of a system for obtaining video analytic output, according to one or more embodiments shown and described herein.

Referring to FIG. 2, the system 200 includes a vehicle system 210 and the server 240.

The vehicle system 210 includes one or more processors 212. Each of the one or more processors 212 may be any device capable of executing machine-readable and executable instructions. Each of the one or more processors 212 may be a controller, an integrated circuit, a microchip, a computer, or any other computing device. One or more processors 212 are coupled to a communication path 214 that provides signal interconnectivity between various modules of the system. The communication path 214 may communicatively couple any number of processors 212 with one another, and allow the modules coupled to the communication path 214 to operate in a distributed computing environment. Each of the modules may operate as a node that may send and/or receive data. As used herein, the term “communicatively coupled” means that coupled components are capable of exchanging data signals with one another such as electrical signals via a conductive medium, electromagnetic signals via air, optical signals via optical waveguides, and the like.

The communication path 214 may be formed from any medium that is capable of transmitting a signal such as conductive wires, conductive traces, optical waveguides, or the like. In some embodiments, the communication path 214 may facilitate the transmission of wireless signals, such as WiFi, Bluetooth®, Near Field Communication (NFC), and the like. The communication path 214 may be formed from a combination of mediums capable of transmitting signals. In one embodiment, the communication path 214 comprises a combination of conductive traces, conductive wires, connectors, and buses that cooperate to permit the transmission of electrical data signals to components such as processors, memories, sensors, input devices, output devices, and communication devices. The communication path 214 may comprise a vehicle bus, such as a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The vehicle system 210 includes one or more memory modules 216 coupled to the communication path 214 and may contain non-transitory computer-readable medium comprising RAM, ROM, flash memories, hard drives, or any device capable of storing machine-readable and executable instructions such that the machine-readable and executable instructions can be accessed by the one or more processors 212. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored in the one or more memory modules 216. The machine-readable and executable instructions may be written in a hardware description language (HDL), such as logic implemented via either a field-programmable gate array (FPGA) configuration or an application-specific integrated circuit (ASIC), or their equivalents. The methods described herein may be implemented in any conventional computer programming language, as pre-programmed hardware elements, or as a combination of hardware and software components. The one or more processors 212 along with the one or more memory modules 216 may operate as a controller for the vehicle system 210.

Still referring to FIG. 2, the vehicle system 210 includes one or more sensors 218. One or more sensors 218 may be any device having an array of sensing devices capable of detecting radiation in an ultraviolet wavelength band, a visible light wavelength band, or an infrared wavelength band. One or more sensors 218 may detect the presence of the vehicle system 210, the presence of the remote vehicle system 220, the location of the vehicle system 210, the location of the remote vehicle system 220, the distance between the vehicle system 210 and the remote vehicle system 220. One or more sensors 218 may have any resolution. In some embodiments, one or more optical components, such as a mirror, fish-eye lens, or any other type of lens may be optically coupled to one or more sensors 218. In some embodiments, one or more sensors 218 may provide image data to one or more processors 212 or another component communicatively coupled to the communication path 214. In some embodiments, one or more sensors 218 may provide navigation support. In embodiments, data captured by one or more sensors 218 may be used to autonomously or semi-autonomously navigate the vehicle system 210. One or more sensors 218 may obtain the video data 110 (shown in FIG. 1A).

The vehicle system 210 includes a satellite antenna 215 coupled to the communication path 214 such that the communication path 214 communicatively couples the satellite antenna 215 to other modules of the vehicle system 210. The satellite antenna 215 is configured to receive signals from global positioning system satellites. In one embodiment, the satellite antenna 215 includes one or more conductive elements that interact with electromagnetic signals transmitted by global positioning system satellites. The received signal is transformed into a data signal indicative of the location (e.g., latitude and longitude) of the satellite antenna 215 or an object positioned near the satellite antenna 215, by one or more processors 212.

The vehicle system 210 includes one or more vehicle sensors 213. Each of one or more vehicle sensors 213 is coupled to the communication path 214 and communicatively coupled to one or more processors 212. One or more vehicle sensors 213 may include one or more motion sensors for detecting and measuring motion and changes in the motion of the vehicle system 210. The motion sensors may include inertial measurement units. Each of the one or more motion sensors may include one or more accelerometers and one or more gyroscopes. Each of one or more motion sensors transforms sensed physical movement of the vehicle into a signal indicative of an orientation, a rotation, a velocity, or an acceleration of the vehicle. One or more vehicle sensors 213 may obtain the video data 110 (shown in FIG. 1A).

Still referring to FIG. 2, the vehicle system 210 includes a network interface hardware 217 for communicatively coupling the vehicle system 210 to the server 240. The network interface hardware 217 may be communicatively coupled to the communication path 214 and may be any device capable of transmitting and/or receiving data via a network. The network interface hardware 217 may include a communication transceiver for sending and/or receiving any wired or wireless communication. For example, the network interface hardware 217 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 217 includes hardware configured to operate in accordance with the Bluetooth® wireless communication protocol. The network interface hardware 217 of the vehicle system 210 may transmit its data to the server 240. For example, the network interface hardware 217 of the vehicle system 210 may transmit vehicle data, location data, maneuver data, and the like to the server 240.

The vehicle system 210 may connect with one or more external vehicle systems and/or external processing devices (e.g., a cloud server, an edge server 140 (shown in FIG. 1A), or both) via a direct connection. The direct connection may be a vehicle-to-vehicle connection (“V2V connection”), a vehicle-to-everything connection (“V2X connection”), or an mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure.

Vehicles may function as infrastructure nodes to form a mesh network and connect dynamically on an ad-hoc basis. In this way, vehicles may enter and/or leave the network at will, such that the mesh network may self-organize and self-modify over time. The network may include vehicles forming peer-to-peer networks with other vehicles or utilizing centralized networks that rely upon certain vehicles and/or infrastructure elements. The network may include networks using the centralized server and other central computing devices to store and/or relay information between vehicles.

Still referring to FIG. 2, the vehicle system 210 may be communicatively coupled to the server 240 by the network 270. In one embodiment, the network 270 may include one or more computer networks (e.g., a personal area network, a local area network, or a wide area network), cellular networks, satellite networks and/or a global positioning system and combinations thereof. The vehicle system 210 may be communicatively coupled to the network 270 via a wide area network, a local area network, a personal area network, a cellular network, a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the server 240 includes one or more processors 244, one or more memory modules 246, a network interface hardware 248, one or more vehicle sensors 249, and a communication path 242 communicatively connected to the other components of the vehicle system 210. The components of the server 240 may be structurally similar to and have similar functions as the corresponding components of the vehicle system 210 (e.g., the one or more processors 244 correspond to the one or more processors 212, the one or more memory modules 246 correspond to the one or more memory modules 216, the one or more vehicle sensors 249 correspond to the one or more vehicle sensors 213, the communication path 242 corresponds to the communication path 214, and the network interface hardware 248 corresponds to the network interface hardware 217).

It should be understood that the components illustrated in FIG. 2 are merely illustrative and are not intended to limit the scope of this disclosure. More specifically, while the components in FIG. 2 are illustrated as residing within the vehicle system 210 the remote vehicle system 220, or both, this is a non-limiting example. In some embodiments, one or more of the components may reside external to the vehicle system 210, the remote vehicle system 220, or both, such as with the server 240.

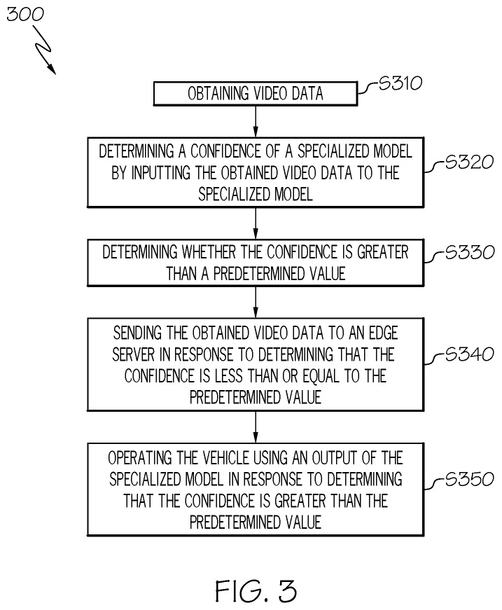

FIG. 3 depicts a flowchart for a method of for obtaining video analytic output, according to one or more embodiments shown and described herein. The method 300 may be executed by the system 10 as depicted in FIGS. 1A-1B as described herein. Additionally, the method 300 will be described with reference to the elements depicted in FIGS. 1A, 1B, and 2.

Referring to FIGS. 1A, 1B, 2, and 3, at step S310, a controller, for example, the controller of the vehicle 120 may obtain video data. The video data 110 may include information about the velocity of the vehicle 120, the acceleration of the vehicle 120, the driving direction of the vehicle 120, environments, such as weather, road surface conditions, traffic signs, other surroundings of the vehicle 120, or combinations thereof. The video data 110 may be obtained by the image sensors.

Still referring to FIGS. 1A, 1B, 2, and 3, at step S320, the controller may determine a confidence of the specialized model 130 by inputting the obtained video data to the specialized model 130. In some embodiments, the confidence of the specialized model 130 may be indicated by one of numbers from 0 to 10. The specialized model 130 may be included in the vehicle 120. The specialized model 130 may be produced by compressing a general model 141.

Still referring to FIGS. 1A, 1B, 2, and 3, at step S330, the controller may determine whether the confidence is greater than a predetermined value. In response to determining that the confidence is greater than the predetermined value, the controller may not send the obtained video data 110, the specialized model 130, or both, to the edge server 140. In response to determining that the confidence is greater than the predetermined value, the controller may determine the obtained video analytic output from the vehicle 120 as final video analytic output for operating the vehicle 120.

Still referring to FIGS. 1A, 1B, 2, and 3, at step S340, the controller may send the obtained video data 110 to the edge server 140 in response to determining that the confidence is less than or equal to the predetermined value. The controller may further send the obtained video analytic data from the vehicle 120 to the edge server 140.

Still referring to FIGS. 1A, 1B, 2, and 3, at step S350, the controller may operate the vehicle 120 using an output of the specialized model in response to determining that the confidence is greater than the predetermined value. The controller may operate the vehicle 120 using an output, such as video analytic output, of the specialized model 130 in response to determining that the confidence is greater than the predetermined value. For example, the controller may operate the vehicle 120 to start, change a driving direction, change a velocity, change an acceleration, stop, change a temperature of the vehicle 120, or combinations thereof, using an output of the specialized model 130.

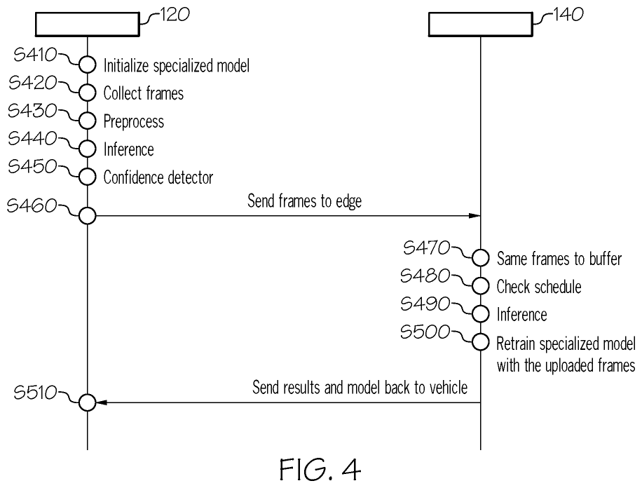

FIG. 4 depicts a flowchart for a method of for obtaining video analytic output, according to one or more embodiments shown and described herein. The method may be executed by the system 10 as depicted in FIGS. 1A-1B as described herein. Additionally, the method will be described with reference to the elements depicted in FIGS. 1A, 1B, and 2.

Referring to FIGS. 1A, 1B, 2, and 4, at step S410, a controller, for example, the controller of the vehicle 120, may initialize the specialized model 130. The vehicle 120 may include the specialized model 130.

Still referring to FIGS. 1A, 1B, 2, and 4, at step S420, the controller of the vehicle 120 may collect video frames. For example, the controller of the vehicle 120 may obtain video data including information about the velocity of the vehicle 120, the acceleration of the vehicle 120, the driving direction of the vehicle 120, environments, such as weather, road surface conditions, traffic signs, other surroundings of the vehicle 120, or combinations thereof. The video data 110 may be obtained by the image sensors.

Still referring to FIGS. 1A, 1B, 2, and 4, at step S430, the controller of the vehicle 120 may preprocess the obtained video data 110 to produce reduced size of the video data 110. In some embodiments, the controller of the vehicle 120 may conduct a sampling method, a subsampling method, or both, to produce reduced size of the video data 110.

Still referring to FIGS. 1A, 1B, 2, and 4, at step S440, the controller of the vehicle 120 may perform an inference to obtain video analytic output. The controller of the vehicle 120 may input the obtained video data 110 or preprocessed obtained video data 110 into a trained model, such as a specialized model 130, to obtain video analytic output.

Still referring to FIGS. 1A, 1B, 2, and 4, at step S450, the controller of the vehicle 120 may determine a confidence of a specialized model 130. The controller of the vehicle 120 may determine a confidence of the specialized model 130 by inputting the obtained video data to the specialized model 130. The controller of the vehicle 120 may determine whether the confidence is greater than a predetermined value.

Still referring to FIGS. 1A, 1B, 2, and 4, at step S460, in response to determining that the confidence is less than or equal to the predetermined value, the controller of the vehicle 120 may send the obtained video data 110, the specialized model 130, the obtained video analytic data from the vehicle 120, or combinations thereof, to the edge server 140.

In one or more embodiments, in response to determining that the confidence is greater than the predetermined value, the controller of the vehicle 120 may not send the obtained video data 110, the specialized model 130, or both, to the edge server 140. In response to determining that the confidence is greater than the predetermined value, the vehicle 120 may determine the obtained video analytic output from the vehicle 120 as final video analytic output for operating the vehicle 120.

Still referring to FIGS. 1A, 1B, 2, and 4, at step S470, a controller, for example, the controller of the edge server 140, may receive the obtained video data 110, the specialized model 130, or both, from the vehicle 120. The controller of the edge server 140 may store the obtained video data 110, the specialized model 130, or both, in the frame buffer.

Still referring to FIGS. 1A, 1B, 2, and 4, at step S480, the controller of the edge server 140 may determine whether the edge server 140 is available for processing the video data 110 received from the vehicle 120. In response to determining that the edge server 140 is not available for processing the video data 110 received from the vehicle 120, the controller of the edge server 140 may wait, without inputting the video data to the general model 141, retrain the specialized model 130, or both, until the edge server 140 is available for processing.

Still referring to FIGS. 1A, 1B, 2, and 4, at step S490, in response to determining that the edge server 140 is available for processing the video data 110 received from the vehicle 120, the controller of the edge server 140 may perform an inference to obtain video analytic output. The controller of the edge server 140 may input the obtained video data 110 into a trained model, such as a general model 141, to obtain video analytic output.

Still referring to FIGS. 1A, 1B, 2, and 4, at step S500, in response to determining that the edge server 140 is available for processing the video data 110 received from the vehicle 120, the controller of the edge server 140 may retrain the specialized model 130 with the obtained video data 110 to increase the confidence of the specialized model 130 greater than the predetermined value.

Still referring to FIGS. 1A, 1B, 2, and 4, at step S510, the controller of the edge server 140 may obtain the video analytic output, the retrained specialized model, or both. The controller of the edge server 140 may send the video analytic output, the retrained specialized model, the obtained video data 110 from the plurality of vehicles including the vehicle 120, or combinations thereof, to the controller of the vehicle 120.

The controller of the vehicle 120 may operate the vehicle 120 using an output, such as video analytic output, of the specialized model 130 in response to determining that the confidence is greater than the predetermined value. For example, the controller may operate the vehicle 120 to start, change a driving direction, change a velocity, change an acceleration, stop, change a temperature of the vehicle 120, or combinations thereof, using an output of the specialized model 130.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system for obtaining video analytic output comprising:
a vehicle comprising a controller configured to:
obtain video data;
determine a confidence of a specialized model by inputting the obtained video data to the specialized model;
determine whether the confidence is greater than a predetermined value;
send the obtained video data to an edge server in response to determining that the confidence is less than or equal to the predetermined value; and
operate the vehicle using an output of the specialized model in response to determining that the confidence is greater than the predetermined value.

2. The system according to claim 1, wherein the specialized model is included in the vehicle.

3. The system according to claim 1, wherein a general model in the edge server is compressed to the specialized model.

4. The system according to claim 3, wherein a number of objects or classes recognized by the specialized model is less than a number of objects or classes recognized by the general model.

5. The system according to claim 3, wherein a number of hidden layers of the specialized model is less than a number of hidden layers of the general model.

6. The system according to claim 3, wherein parameters of the general model are compressed to obtain parameters of the specialized model.

7. The system according to claim 3, wherein the general model comprises a machine learning model for processing frames in the video data.

8. The system according to claim 1, wherein the edge server is configured to:
retrain the specialized model received from the vehicle; and
transmit the retrained specialized model to the vehicle.

9. The system according to claim 8, wherein the edge server retrains the specialized model with a general model in the edge server.

10. The system according to claim 1, wherein the edge server is configured to:
determine whether the edge server is available for processing the video data received from the vehicle;
store the video data received from the vehicle in a frame buffer in response to determining that the edge server is not available; and
input the video data to a general model in the edge server to obtain the video analytic output in response to determining that the edge server is available.

11. The system according to claim 1, wherein the controller is further configured to:
send the specialized model to the edge server in response to determining that the confidence is less than or equal to the predetermined value.

12. A method for obtaining video analytic output comprising:
obtaining video data;
determining a confidence of a specialized model by inputting the obtained video data to the specialized model;
determining whether the confidence is greater than a predetermined value;
sending the obtained video data to an edge server in response to determining that the confidence is less than or equal to the predetermined value; and
operating a vehicle using an output of the specialized model in response to determining that the confidence is greater than the predetermined value.

13. The method according to claim 12, wherein the specialized model is included in the vehicle.

14. The method according to claim 12, wherein a general model in the edge server is compressed to the specialized model.

15. The method according to claim 14, wherein a number of objects or classes recognized by the specialized model is less than a number of objects or classes recognized by the general model.

16. The method according to claim 14, wherein a number of hidden layers of the specialized model is less than a number of hidden layers of the general model.

17. The method according to claim 14, wherein parameters of the general model are compressed to obtain parameters of the specialized model.

18. The method according to claim 14, wherein the general model comprises a machine learning model for processing frames in the obtained video data.

19. The method according to claim 12, wherein the edge server is configured to:
retrain the specialized model received from the vehicle; and
transmit the retrained specialized model to the vehicle.

20. The method according to claim 19, wherein the edge server retrains the specialized model with a general model in the edge server.
